(19) United States
(12) Patent Application Publication
(10) Pub. No.: US 2018/0301948 A1
(43) Pub. Date: Oct. 18, 2018

(54) ROTOR, MOTOR HAVING THE ROTOR AND METHOD FOR REDUCING A TORQUE RIPPLE OF THE ROTOR

(71) Applicant: Nidec Corporation, Kyoto (JP)

(72) Inventors: Yu-Wei HSU, Taipei City (CN); Sheng-Chan YEN, Taipei City (CN); Hsin-Nan LIN, Taipei City (CN); Cheng-Tsung LIU, Kaohsiung City (CN)

(21) Appl. No.: 15/953,607

(22) Filed: Apr. 16, 2018

(30) Foreign Application Priority Data
Apr. 17, 2017 (CN) 2017102496556

(51) Int. Cl. H02K 1/24; H02K 15/00

(52) U.S. Cl. CPC H02K 1/246; H02K 29/03; H02K 15/0012

(57) ABSTRACT

The embodiments of the present disclosure provide a rotor, a motor having the rotor and a method for reducing a torque ripple of the rotor. The rotor rotates taking a rotation axis as a center, the rotor including electromagnetic steel sheets laminated in an axial direction; and a plurality of flux barriers penetrating the electromagnetic steel sheets in an axial direction, wherein when observed in an axial direction, in any two imaginary straight lines passing through at least one flux barrier from the center of the rotor and extending to a radial outer side, sums of the lengths of line segments superimposed on flux barriers respectively for the two imaginary straight lines keep consistent. With the embodiments of the present disclosure, a torque ripple of a rotor can be reduced, thereby vibrations, noise and losses of a motor provided with the rotor are reduced.

### CROSS REFERENCE TO RELATED APPLICATIONS

This application claims the benefit of priority to Chinese Patent Application No. 2017102496556 filed on Apr. 17, 2017. The entire contents of this application are hereby incorporated herein by reference.

### BACKGROUND OF THE INVENTION

1. Field of the Invention

The present application relates to a motor, particularly to a rotor, a motor having the rotor and a method for reducing a torque ripple of the rotor.

2. Description of the Related Art

In a synchronous reluctance motor, generally a flux barrier is designed on a rotor to improve the feature of the motor. When a flux flows through the rotor, due to blocking of the flux barrier, a reluctance increases in a flux barrier layer. The greater a difference in rotor reluctances is, the greater reluctance torques generated by identical currents are. Thus when the motor rotates, an instantaneous fluctuation (change) of a rotor reluctance is too large, and a drastic torque ripple (i.e. a torque fluctuation, a torque pulse) is caused, thereby causing great vibrations, noise and additional losses on the motor.

In order to solve this problem, it is known that a plurality of flux barriers can be formed on a rotor, a torque ripple is reduced by making a relative relationship between end portions of the flux barriers of the rotor and a stator be different, so as to reduce noise. However, due to limitations of a shape and a position of the flux barriers, discontinuous or rapid fluctuation changes occur on the reluctance, a high harmonic component is generated. The high harmonic components will finally result in an increasing of the torque ripple, which is presented in a manner of vibration noise and thermal energy, thereby the final motor efficiency is affected and the torque is declined.

It should be noted that the above introduction to the Background is just to facilitate a clear and complete description of the technical solution of the present application, and is elaborated to facilitate the understanding of persons skilled in the art. It cannot be considered that the above technical solutions are known by persons skilled in the art only because these solutions are elaborated in the Background of the present application.

### SUMMARY OF THE INVENTION

In order to solve the above problem mentioned in the Background, the embodiments of the present disclosure provide a rotor, a motor having the rotor and a method for reducing a torque ripple of the rotor.

According to a first aspect of the embodiments of the present disclosure, a rotor is provided, the rotor rotating taking a rotation axis as a center, wherein, the rotor includes: electromagnetic steel sheets laminated in an axial direction; and a plurality of flux barriers penetrating the electromagnetic steel sheets in an axial direction, wherein when observed in an axial direction, in any two imaginary straight lines passing through the at least one flux barrier from the center of the rotor and extending to an outer side in a radial direction, sums of the lengths of line segments superimposed on flux barriers respectively for the two imaginary straight lines keep consistent.

According to a second aspect of the embodiments of the present disclosure, a motor is provided, the motor having a stator and the rotor as described in the above first aspect.

According to a third aspect of the embodiments of the present disclosure, a method for reducing a torque ripple of a rotor is provided, the rotor rotating taking a rotation axis as a center and having electromagnetic steel sheets laminated in an axial direction and a plurality of flux barriers penetrating the electromagnetic steel sheets in an axial direction, the method includes: machining the rotor, such that the following condition is satisfied: when observed in an axial direction, in any two imaginary straight lines passing through at least one flux barrier from the center of the rotor and extending to an outer side in a radial direction, sums of the lengths of line segments superimposed on flux barriers respectively for the two imaginary straight lines keep consistent.

An advantageous of the embodiments of the present disclosure lies in that with the embodiments of the present disclosure, a torque ripple of a rotor can be reduced, thereby vibrations, noise and losses of a motor provided with the rotor are reduced.

Referring to the later description and figures, embodiments of the present disclosure are disclosed in detail. It should be understood that the embodiments of the present disclosure are not limited in terms of the scope. Within the scope of the principle of the appended claims, the embodiments of the present disclosure include many changes, modifications and equivalents.

Features that are described and/or illustrated with respect to one embodiment may be used in the same way or in a similar way in one or more other embodiments and in combination with or instead of the features of the other embodiments.

It should be emphasized that the term “comprise/include/have” when being used herein specifies the presence of features, integers or components, but does not preclude the presence or addition of one or more other features, integers or components.

The above and other elements, features, steps, characteristics and advantages of the present invention will become more apparent from the following detailed description of the preferred embodiments with reference to the attached drawings.

### BRIEF DESCRIPTION OF THE DRAWINGS

From the detailed description with reference to the following figures, the above and other purposes, features and advantages of the embodiments of the present disclosure will become more obvious, in the figures:

FIG. 1 is a schematic diagram showing the appearance of the rotor of Embodiment 1 of the present disclosure.

FIG. 2 is a top view of the rotor of Embodiment 1 of the present disclosure.

FIG. 3 is another top view of the rotor of Embodiment 1 of the present disclosure.

FIG. 4 is a schematic diagram showing the forming principle of air gap distribution of flux barriers of the rotor.

FIG. 5 is a schematic diagram showing a curve of the air gap distribution of flux barriers of a rotor in the prior art with a rotor angle increasing from 0° to 90°.

FIG. 6 is a schematic diagram showing a comparison between a curve of the air gap distribution of flux barriers of a rotor in the prior art with a rotor angle increasing from 0° to 90° and a curve of the air gap distribution of flux barriers of the rotor according to the embodiments of the present disclosure with a rotor angle increasing from 0° to 90°.

FIG. 7 is a top view of the motor of Embodiment 2 of the present disclosure.

FIG. 8 is a flow diagram of the method of Embodiment 3 of the present disclosure.

### DETAILED DESCRIPTION OF THE PREFERRED EMBODIMENTS

Referring to the figures, through the following Description, the above and other features of the present disclosure will become obvious. The Description and figures specifically disclose the specific embodiments of the present disclosure, showing partial embodiments which can adopt the principle of the present disclosure. It should be understood that the present disclosure is not limited to the described embodiments, and includes all the modifications, variations and equivalents falling within the scope of the appended claims.

In the following description of the present disclosure, for ease of description, a center line around which a rotor can rotate is referred to as “a rotation axis”, a direction parallel to a direction extending along the rotation axis is referred to as “an axial direction”, a direction of the radius taking the rotation axis as a center is referred to as “a radial direction”, and a direction of the circumference taking the rotation axis as a center is referred to as “a circumferential direction”.

The rotor, the motor and the method for reducing a torque ripple of the rotor in the embodiments of the present disclosure will be described below in detail with reference to the figures.

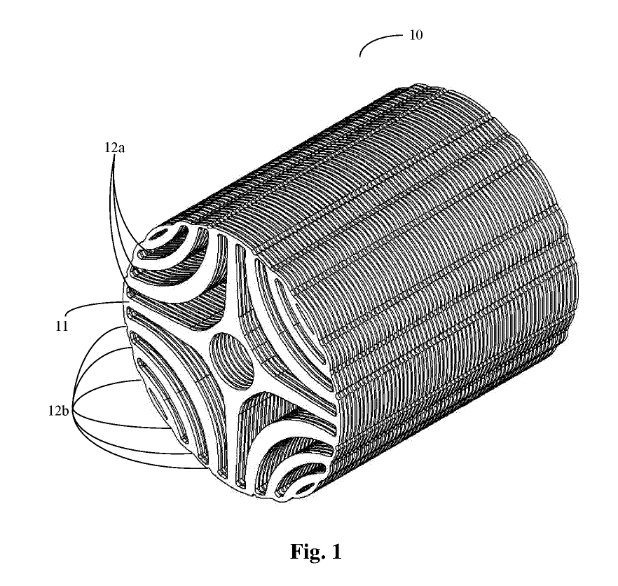

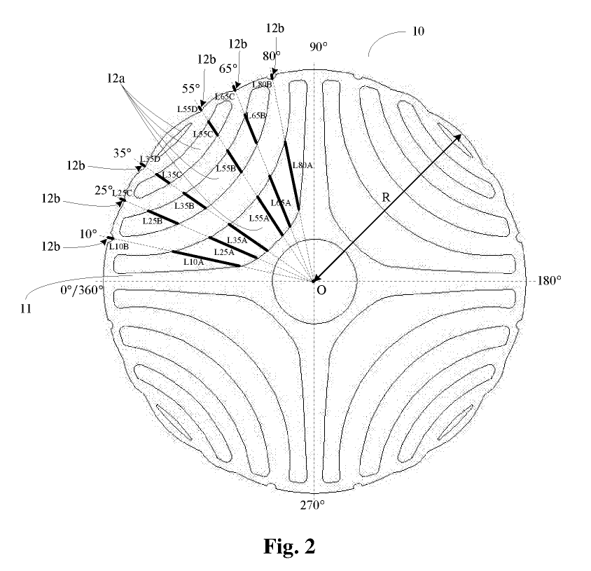

The present Embodiment 1 provides a rotor. FIG. 1 is a schematic diagram showing the appearance of the rotor of the present embodiment. FIG. 2 is a top view of the rotor of the present embodiment.

As shown in FIG. 1 and FIG. 2, the rotor 10 rotates taking the rotation axis O as a center, the rotor 10 has electromagnetic steel sheets 11 laminated in an axial direction, and a plurality of flux barriers 12 (including 12a and 12b) penetrating the electromagnetic steel sheets 11 in an axial direction.

In the present embodiment, as shown in FIG. 2, when observed in an axial direction, in any two imaginary straight lines passing through at least one flux barrier 12 from the center of the rotor 10 and extending to an outer side in a radial direction, sums of the lengths of line segments (i.e. the line segments represented by a heavy line in FIG. 1) superimposed on the flux barriers 12 respectively for the two imaginary straight lines keep consistent. That is to say, taking, in a circumferential direction, a certain straight line passing through the center of the rotor 10 but not passing through any flux barrier 12 as a reference, sums of the lengths of line segments superimposed on the flux barriers 12 for imaginary straight lines at any angles in a circumferential direction keep consistent.

In the above embodiment, by making sums of the lengths of line segments superimposed on the flux barriers 12 respectively for any two imaginary straight lines keep consistent, flux barriers at angles with a drastic change is corrected. Therefore, a torque ripple of a rotor can be reduced, thereby vibrations, noise and losses of a motor provided with the rotor are reduced.

In the present embodiment, a determination criterion of “keep consistent” may be specifically set based on actual situations. For example, it can be set to “be equal”. In addition, since an error may exist in actual measurement and machining, the determination criterion of “keep consistent” can be also set to “a difference between each other is within a prescribed range”.

In the present embodiment, when the determination criterion of “keep consistent” is set to be “a difference between each other is within a prescribed range”, when observed in an axial direction, the above rotor 10 can be configured so that a difference between a sum of the lengths of line segments passing through the flux barriers 12 on any one imaginary straight line and a sum of the lengths of line segments passing through the flux barriers 12 on any other one imaginary straight line is not greater than a prescribed threshold, the above rotor 10 can be also configured so that a difference between a sum of the lengths of line segments passing through the flux barriers 12 on any one imaginary straight line and a sum of the lengths of line segments passing through the flux barriers 12 on any other one imaginary straight line is smaller than a prescribed threshold.

In the present embodiment, the above threshold can be set to be any value based on an actual need. When the determination criterion is set to be “the above difference being not greater than a prescribed threshold”, the threshold can be set to be 0. In this situation, actually the above difference is required to be 0, which is equivalent to a situation in which the two sums of lengths for calculating the above difference are equal.

The above imaginary straight lines and line segments will be described below taking FIG. 2 as an example.

As shown in FIG. 2, the straight line (as shown by a dash dot line in FIG. 2) extending from the center O to the left side of the paper is set to be a 0° straight line, in this situation, the angles of the straight lines extending from the center O to the upper side, right side and lower side of the paper are 90°, 180°, 270° respectively. These straight lines do not pass through the flux barriers, thus are not imaginary straight lines. For ease of the following description, the 0° straight line serves as a reference straight line, an angle of any straight line extending from the center O to an outer side in a radial direction, with respect to the reference straight line, is referred to as “a rotor angle” of the any straight line, and the reference straight line is a straight line with a rotor angle being 0°.

As shown in FIG. 2, the straight lines with rotor angles being 10°, 25°, 35°, 55°, 65° and 80° are straight lines passing through at least one flux barrier 12 from the center O and extending to an outer side in a radial direction, i.e. imaginary straight lines. The description is as follows taking these imaginary straight lines as an example. As shown in FIG. 2, a sum of the lengths of line segments superimposed on the flux barriers 12 for the imaginary straight line with a rotor angle being 10° is (L10A+L10B). Similarly, the sums of the lengths of line segments superimposed on the flux barriers 12 for the imaginary straight lines with rotor angles being 25°, 35°, 55°, 65° and 80° are respectively (L25A+L25B+L25C), (L35A+L35B+L35C+L35C+L35D), (L55A+L55B+L55C+L55D), (L65A+L65B+L65C), and (L80A+L80B).

In the present embodiment, by taking the imaginary straight lines with rotor angles being 10°, 25°, 35°, 55°, 65° and 80° as an example, the above sums of the lengths keep consistent may be:

L10A+L10B≈L25A+L25B+L25C≈L35A+L35B+L35C+L35C+L35D≈L55A+L55B+L55C+L55D≈L65A+L65B+L65C≈L80A+L80B.

In the present embodiment, as shown in FIG. 2, the flux barriers 12 may include flux barriers 12a and flux barriers 12b. For example, the flux barriers 12a are provided at an inner side in a radial direction of the outer circumferential surface of the rotor 10, and the flux barriers 12b are recessed portions sunken to an inner side in a radial direction provided on the outer circumferential surface of the rotor 10. Thereby, each recessed portion 12b serves as one of the plurality of flux barriers 12. Namely, by machining the outer circumferential surface of the rotor 10, the recessed portions 12b as flux barriers are formed, such that sums of the lengths of line segments superimposed on the flux barriers 12 (i.e. the flux barriers 12a and the recessed portions 12b) for any imaginary straight lines keep consistent.

Here, the length of the line segment superimposed on a recessed portion 12b for an imaginary straight line refers to, in a direction of the imaginary straight line, a distance from the bottom of the recessed portion 12b to a circle which takes the rotation axis O as a center and takes the radius R of a rotor as a radius.

In the present embodiment, the recessed portions 12b may be formed into any shape, such as an arc shape, or other shapes such as a polygon (for example a rectangle, a trapezoid, etc.).

In the present embodiment, the flux barriers 12 may only include the flux barriers 12a, and does not include the recessed portions 12b provided on an outer circumferential surface of a rotor. in this situation, in order to make sums of the lengths of line segments superimposed on the flux barriers 12 (in this situation “the flux barriers 12” refers to “the flux barriers 12a”) respectively for any two imaginary straight lines keep consistent, the line segments on the adjusted flux barriers 12a in a direction of imaginary straight lines can increase or decrease by adjusting at least one of the size, shape, position and quantity of the flux barriers 12a, such that the sums of the lengths keep consistent.

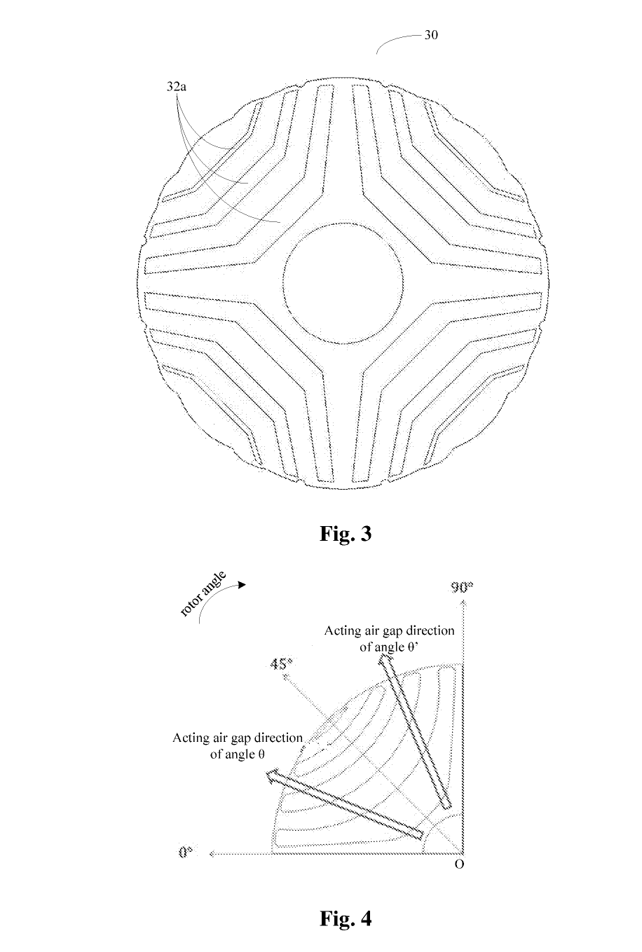

In the present embodiment, the flux barriers 12a may be set to be in any shape based on an actual demand. For example, they can be set to be circular arc shaped or polygonal. As shown in FIG. 1 and FIG. 2, the flux barriers 12a are circular arc shaped. FIG. 3 is another top view of the rotor of the present embodiment. As shown in FIG. 3, the flux barriers 32a of the rotor 30 are polygonal.

In the present embodiment, the plurality of flux barriers 12 can be constructed as multiple sets of flux barrier groups. For example, as shown in FIG. 2, the plurality of flux barriers 12 are divided as per the 0°/360° straight line, the 90° straight line, the 180° straight line and the 270° straight line, the plurality of flux barriers 12 constitute four sets of flux barrier groups, i.e. a set of flux barrier group with the angles within a range of 0°-90°, a set of flux barrier group with the angles within a range of 90°-180°, a set of flux barrier group with the angles within a range of 180°-270°, and a set of flux barrier group with the angles within a range of 270°-360°. However, the embodiment of the present disclosure is not limited to this, the plurality of flux barriers 12 may constitute e.g. six or eight sets of barrier groups.

In the present embodiment, the multiple sets of flux barrier groups can be symmetrically configured with respect to the rotation axis O. For example, as shown in FIG. 2, the above four sets of flux barrier groups are symmetrically configured with respect to the rotation axis O. Thereby, a torque ripple can be reduced uniformly in the entire rotor.

FIG. 4 is a schematic diagram showing the forming principle of air gap distribution of flux barriers of the rotor. A flux barrier in a rotor plays a role as an air gap. The air gap distribution for flux barriers of a rotor corresponds to an accumulated total of all air gaps in a direction from the center O of the rotor toward a stator (i.e. an outer side in a radial direction). As shown in FIG. 4, the flux barriers can be symmetrical with respect to a direction that a rotor angle being 45°, for example in FIG. 4, the acting air gap direction of the angle θ and the acting air gap direction of the angle θ′ are symmetrical with respect to the 45° direction.

Therefore, in order to more easily distinguish a difference between the rotor of the embodiments of the present disclosure and the rotors other than the embodiments of the present disclosure, the description is illustrated by taking the change of an accumulated total of air gaps in a direction from the center O of the rotor toward a stator, with the rotor angle increasing from 0° to 90°, as an example.

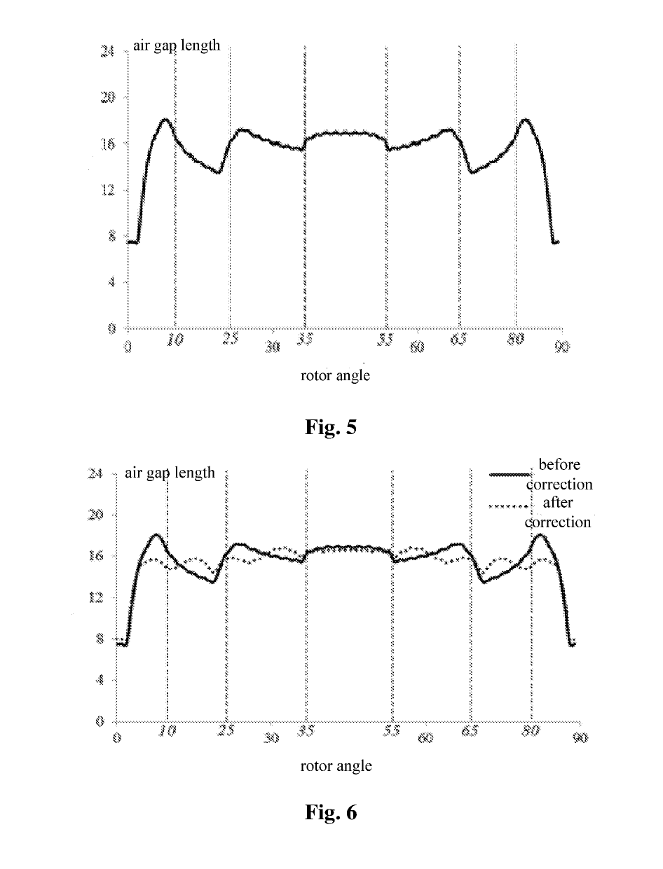

FIG. 5 illustrates an example of a curve of the air gap distribution of flux barriers of a rotor in the prior art with a rotor angle increasing from 0° to 90°, as a comparative example to the embodiments of the present disclosure. The vertical axis in FIG. 5 represents an air gap length of the flux barrier, which can characterize an air gap distribution of flux barriers, and the horizontal axis represents a rotor angle. Any curve can be decomposed into a superposition of multiple sinusoidal waveforms. However, if a curve changes dramatically, its equivalent sinusoidal waveforms will contain higher harmonics, thereby producing vibrations, noise and additional losses. As shown in FIG. 5, there may be dramatic changes at certain rotor angles in an air gap distribution of flux barriers of a rotor in the prior art. Specifically, as an example, in FIG. 5, the rotor angles with dramatic changes are 10°, 25°, 35°, 55°, 65°, 80°.

In the embodiment, by making sums of the lengths of line segments superimposed on the flux barriers 12 respectively for any two imaginary straight lines keep consistent, the flux barriers 12 can be corrected at positions corresponding to the rotor angles with dramatic changes, which are 10°, 25°, 35°, 55°, 65°, 80°, such that the air gap lengths at the rotor angles with dramatic changes are compensated.

In other words, with the present embodiment, in an air gap distribution of corrected flux barriers, regardless of the angle, there is no drastic change, and an air gap distribution curve of corrected flux barriers is smoother. Therefore, higher harmonic components of equivalent sinusoidal waveforms in an air gap distribution curve can be reduced, a torque ripple of a rotor can be reduced, thereby vibrations, noise and losses in a motor are reduced.

FIG. 6 illustrates a curve of the air gap distribution of flux barriers of a rotor in the prior art (flux barriers before correction) with a rotor angle increasing from 0° to 90° (i.e. the curve shown by a solid line in FIG. 6), as a comparative example to the embodiments of the present disclosure, and a curve of the air gap distribution of flux barriers of a rotor according to the embodiments of the present disclosure (flux barriers after correction) with a rotor angle increasing from 0° to 90° (i.e. the curve shown by a dotted line in FIG. 6). As can be seen from FIG. 6, the curve of the air gap distribution of the corrected flux barriers of a rotor is smoother than that of the uncorrected flux barriers of the rotor, that is to say, a torque ripple of the rotor is reduced effectively.

With the present embodiment, a torque ripple of a rotor can be reduced, thereby vibrations, noise and losses of a motor provided with the rotor are reduced.

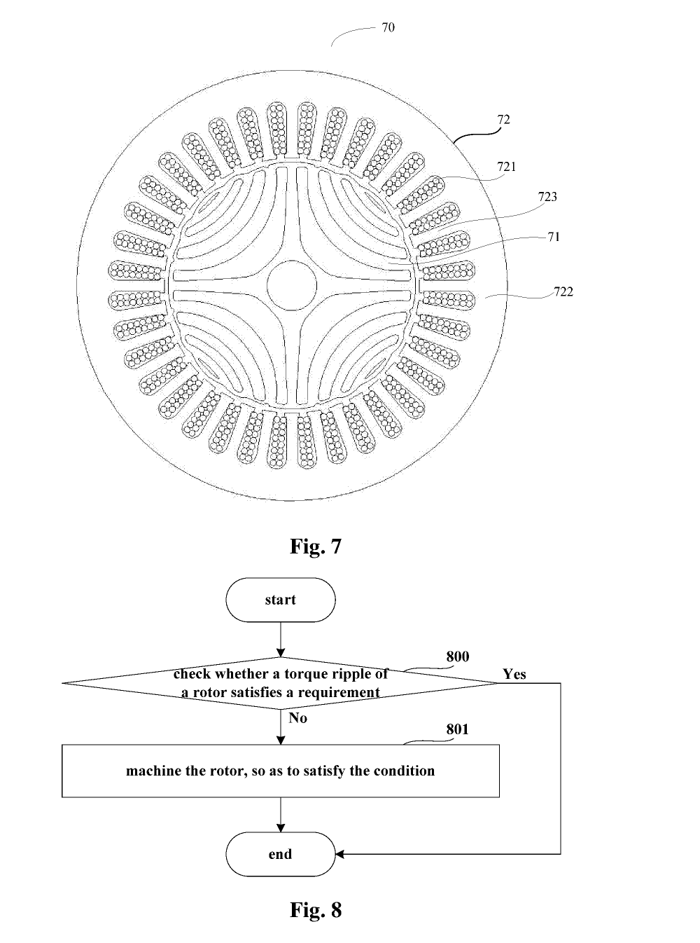

The present Embodiment 2 provides a motor. FIG. 7 is a top view of the motor 70 of the present embodiment.

As shown in FIG. 7, the motor 70 has a rotor 71 and a stator 72.

In the present embodiment, the rotor 71 may be the rotor as described in Embodiment 1. As shown in FIG. 7, in the present embodiment, the stator 72 may include a stator core 722 and a coil 721, the stator core 722 is provided with a plurality of teeth 723 in a circumferential direction, and the coil 721 is wound around the stator core 722 via the plurality of teeth 723. As regards other parts and structure of the motor, the prior art may be referred to, and it is not further described here.

With the present embodiment, vibrations, noise and losses of a motor can be reduced.

In the present embodiment, the motor can be a synchronous reluctance motor. The number of rotor poles of the synchronous reluctance motor may be an arbitrary value, as shown in FIG. 7, for example, the number of rotor poles may be 4. The above Embodiment 1 (for example FIG. 1 to FIG. 3) also illustrates a rotor applied in a reluctance motor with a number of rotor poles being 4. However, a rotor with other number of rotor poles can also be adopted.

In the present embodiment, the motor can be used in any electrical device. For example, it can be used as a motor in household appliances such as an indoor unit of an air conditioner, an outdoor unit of an air conditioner, a water dispenser, a washing machine, a sweeper, a compressor, a blower and a blender, etc., or be used as a motor in various information devices and industrial devices, etc.

The present Embodiment 3 provides a method for reducing a torque ripple of a rotor, the structure of the rotor is as described in the Embodiment 1, and it is not further described here.

FIG. 8 is a flow diagram of the method, please refer to FIG. 8, the method includes:

Step 801: the rotor is machined, such that the following condition is satisfied: when observed in an axial direction, in any two imaginary straight lines passing through at least one flux barrier from the center of the rotor and extending to an outer side in a radial direction, sums of the lengths of line segments superimposed on the flux barrier respectively for the two imaginary straight lines keep consistent.

In the present embodiment, by machining the rotor, such that the above condition is satisfied on the rotor, a torque ripple of the rotor can be reduced, and vibrations, noise and losses of a motor in which the rotor is installed can be reduced.

In one implementation of the present embodiment, as shown in FIG. 8, the method may also include:

Step 800: it is checked whether a torque ripple of the rotor satisfies a requirement, and when the torque ripple of the rotor does not satisfy the requirement, Step 801 is performed, i.e., the rotor is machined, such that the rotor satisfies the above condition.

In the present embodiment, Step 800 is optional. The rotor can also be directly machined, such that the rotor satisfies the above condition.

In the present embodiment, the manner of checking whether a torque ripple of a rotor satisfies a requirement can be set arbitrarily based on an actual need, the present embodiment does not make limitations on this. For example, whether a torque ripple of a rotor satisfies a requirement can be determined based on an air gap distribution of flux barriers of the rotor (e.g. the air gap distribution as shown in FIG. 5).

In the present embodiment, the above condition can be satisfied by machining an outer circumferential surface of a rotor to form a recessed portion sunken to an inner side in a radial direction (e.g. the recessed portion 12b as shown in FIG. 1 or FIG. 2). In such a way, the recessed portion constitutes one of a plurality of flux barriers (e.g. the flux barriers 12 as shown in FIG. 1 or FIG. 2). The specific structure of the recessed portion may be as described in Embodiment 1. Or, one or more of the plurality of flux barriers (e.g. the flux barriers 12a as shown in FIG. 2) can be also machined, such that the line segments on machined flux barriers in a direction along the imaginary straight lines increase or decrease, so as to satisfy the condition. The specific way of machining may be as described in Embodiment 1. In addition, forming a recessed portion on an outer circumferential surface and machining the existing flux barriers can also be combined, such that the above condition is satisfied.

With the method of the present embodiment, a torque ripple of a rotor can be reduced, thereby vibrations, noise and losses of a motor provided with the rotor are reduced.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A rotor rotating taking a rotation axis as a center, characterized in that
the rotor comprises:
electromagnetic steel sheets laminated in an axial direction; and
a plurality of flux barriers penetrating the electromagnetic steel sheets in an axial direction,
wherein when observed in an axial direction, in any two imaginary straight lines passing through at least one flux barrier from the center of the rotor and extending to a radial outer side, sums of the lengths of line segments superimposed on flux barriers respectively for the two imaginary straight lines keep consistent.

2. The rotor according to claim 1, characterized in that when observed in an axial direction, a difference between a sum of the lengths of line segments passing through the flux barriers on any one of the imaginary straight lines and a sum of the lengths of line segments passing through the flux barriers on any other one of the imaginary straight lines is not greater than a prescribed threshold or smaller than a prescribed threshold.

3. The rotor according to claim 1, characterized in that a recessed portion sunken to an inner side in a radial direction is provided on an outer circumferential surface of the rotor, the recessed portion serving as one of the plurality of flux barriers.

4. The rotor according to claim 1, characterized in that the plurality of flux barriers are in a circular arc shape and/or in a polygon shape.

5. The rotor according to claim 1, characterized in that the plurality of flux barriers constitute multiple sets of flux barrier groups, the multiple sets of flux barrier groups being symmetrically configured with respect to the rotation axis.

6. A motor, characterized in that the motor has a stator and the rotor according to claim 1.

7. A method for reducing a torque ripple of a rotor, the rotor rotating taking a rotation axis as a center and having electromagnetic steel sheets laminated in an axial direction and a plurality of flux barriers penetrating the electromagnetic steel sheets in an axial direction, characterized in that the method includes:
machining the rotor, such that the following condition is satisfied: when observed in an axial direction, in any two imaginary straight lines passing through the at least one flux barrier from the center of the rotor and extending to a radial outer side, sums of the lengths of line segments superimposed on flux barriers respectively for the two imaginary straight lines keep consistent.

8. The method for reducing a torque ripple of a rotor according to claim 7, characterized in that the method further includes:
checking whether the torque ripple of the rotor satisfies a requirement,
machining the rotor when the torque ripple of the rotor does not satisfy the requirement.

9. The method for reducing a torque ripple of a rotor according to claim 7, characterized in that machining the rotor includes:
machining an outer circumferential surface of the rotor, to form a recessed portion sunken to an inner side in a radial direction, the recessed portion constituting one of the plurality of flux barriers, so as to satisfy the condition.

10. The method for reducing a torque ripple of a rotor according to claim 7, characterized in that machining the rotor includes:
machining one or more of the plurality of flux barriers, such that the line segments on machined flux barriers in a direction along the imaginary straight lines increase or decrease, so as to satisfy the condition.
